(19) United States
(12) Patent Application Publication
(10) Pub. No.: US 2016/0036491 A1
(43) Pub. Date: Feb. 4, 2016

(54) METHOD AND APPARATUS FOR CROSSTALK MANAGEMENT AMONG DIFFERENT VECTORED GROUPS

(71) Applicant: IKANOS COMMUNICATIONS, INC., Fremont, CA (US)

(72) Inventor: Massimo Sorbara, Freehold, NJ (US)

(21) Appl. No.: 14/816,927

(22) Filed: Aug. 3, 2015

Related U.S. Application Data
(60) Provisional application No. 62/032,351, filed on Aug. 1, 2014.

(51) Int. Cl. H04B 3/32; H04L 5/14

(52) U.S. Cl. CPC H04B 3/32; H04L 5/14

(57) ABSTRACT

The present invention relates generally to data communications, and more particularly to techniques based on the G.fast protocol for managing operation around potentially degrading un-cancellable crosstalk among separate vector groups implemented in a single G.fast based box located at a network distribution point, referred to as a Distribution Point Unit (DPU). In embodiments, techniques according to the invention configure transmission of signals from the different vector groups so as to avoid or prevent transmission of signals, either in the frequency domain or time domain or a combination of the two, from causing severe degradation in performance due to un-cancelled crosstalk among the separate groups.

### CROSS-REFERENCE TO RELATED APPLICATIONS

This application claims priority to co-pending U.S. Provisional Patent Application No. 62/032,351, filed Aug. 1, 2014, the contents of which are hereby incorporated by reference in their entirety.

### FIELD OF THE INVENTION

The present invention relates generally to data communications, and more particularly to methods and apparatuses for managing crosstalk between different vectored groups in a common cable or distribution point. clp BACKGROUND OF THE RELATED ART

ITU-T G.9701 (i.e. G.fast or the G.fast standard) defines a transceiver that operates with time division duplexing (TDD). In the first issue of the G.fast standard, operation is defined in which data modulates discrete tones spanning a bandwidth of approximately 106 MHz to support aggregate bit rates in excess of 1 Gb/s. To facilitate the achievement of the highest bit rates when multiple transceivers are deployed on wire-pairs in a cable where cross-talk is present, G.fast defines a protocol to enable use of vectoring, where the transceivers deployed in the cable operate in synchronism such that the crosstalk characteristics of the cable may be learned and tracked in order that the crosstalk in the cable may be cancelled.

The G.fast transceiver specification is based on the assumption that a single vector group exists which accommodates all of the lines in the DPU. The G.fast standard does not contemplate or address the situation in which more than one vector group exists in the cable. In such a situation, data transmission of each group may occur at the same time, and as a result the crosstalk between separate vector groups remain uncancelled and the performance on all of the lines may become severely degraded if the residual uncancelled crosstalk is large.

Likewise, if a specific implementation of a vectored group has a size that is less than the number of lines in the cable, i.e. the number of lines in a cable is greater than the number of lines in a single vector group, then full crosstalk cancellation cannot be achieved across the wire pairs in the entire cable.

Accordingly, there remains a need for a solution to these problems, among others.

### SUMMARY OF THE INVENTION

The present invention relates generally to data communications, and more particularly to techniques based on the G.fast protocol for managing operation around potentially degrading un-cancellable crosstalk among separate vector groups implemented in a single G.fast based box located at a network distribution point, referred to as a Distribution Point Unit (DPU). In embodiments, techniques according to the invention configure transmission of signals from the different vector groups so as to avoid or prevent transmission signals, either in the frequency domain or time domain or a combination of the two, from causing severe degradation in performance due to un-cancelled crosstalk among the separate groups.

In accordance with these and other aspects, a method of controlling communications by transceivers in a common distribution point unit (DPU) according to embodiments of the invention includes configuring all of the transceivers to use a time division duplex (TDD) physical frame having a downstream set of discrete multitone (DMT) symbol periods and an upstream set of DMT symbol periods; configuring first ones of the transceivers to transmit in a first portion of the downstream set of DMT symbol periods of the physical frame; and configuring second ones of the transceivers to transmit in a second portion of the downstream set of DMT symbol periods of the physical frame, wherein the first and second portions do not contain any common DMT symbol periods in the physical frame.

In further accordance with these and other aspects, a distribution point unit (DPU) according to embodiments of the invention includes a plurality of transceivers, and a dynamic resource allocation (DRA) function, the DRA having circuitry adapted to: configure all of the transceivers to use a time division duplex (TDD) physical frame having a downstream set of discrete multitone (DMT) symbol periods and an upstream set of DMT symbol periods; configure first ones of the transceivers to transmit in a first portion of the downstream set of DMT symbol periods of the physical frame; and configure second ones of the transceivers to transmit in a second portion of the downstream set of DMT symbol periods of the physical frame, wherein the first and second portions do not contain any common DMT symbol periods in the physical frame.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a timing diagram illustrating time division duplexing used in G.fast transceivers;

FIG. 2 is a G.fast Superframe timing diagram;

FIG. 3 is a diagram illustrating a logical TDD frame format for Discontinuous Operation according to the G.fast standard;

FIG. 4 is a block diagram illustrating an example system according to embodiments of the invention;

FIG. 5 is a block diagram illustrating an example DPU containing two vectored groups according to embodiments of the invention;

FIG. 6 is a diagram illustrating timing of two vector groups with non-overlapping transmission periods according to embodiments of the invention;

FIG. 7 is a diagram illustrating two coordinated vector groups with respect to a baseline single vector group according to embodiments of the invention;

FIG. 8 is a diagram illustrating adjusting timing of discontinuous operation to implement different coordinated vector groups according to embodiments of the invention; and

FIG. 9 is a diagram illustrating timing of four vector groups with non-overlapping transmission periods according to embodiments of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

In accordance with certain general aspects, embodiments of the invention are directed to managing operation around potentially degrading un-cancellable crosstalk among separate vector groups implemented in a single G.fast based box located at a network distribution point, referred to as a Distribution Point Unit (DPU). More particularly, the present inventors recognize that when the number of wire-pairs in a cable exceeds the size of the vector group that would cancel the self-crosstalk among the wire pairs within the cable, full crosstalk cancellation cannot be achieved unless the size of vector group is increased to at least equal the number of wire pairs in the cable. The present inventors further recognize that if large enough vector group sizes are not available to support the size of the objective cable for which the equipment is to be deployed, an alternative solution is to implement multiple vector groups in a single box where a central controller would configure the signals sent from each vector group so as to optimize the achievable capacity given the crosstalk among the various vector groups that cannot be cancelled. An example technology where embodiments of the invention can be implemented is G.fast, but the invention is not limited to this example.

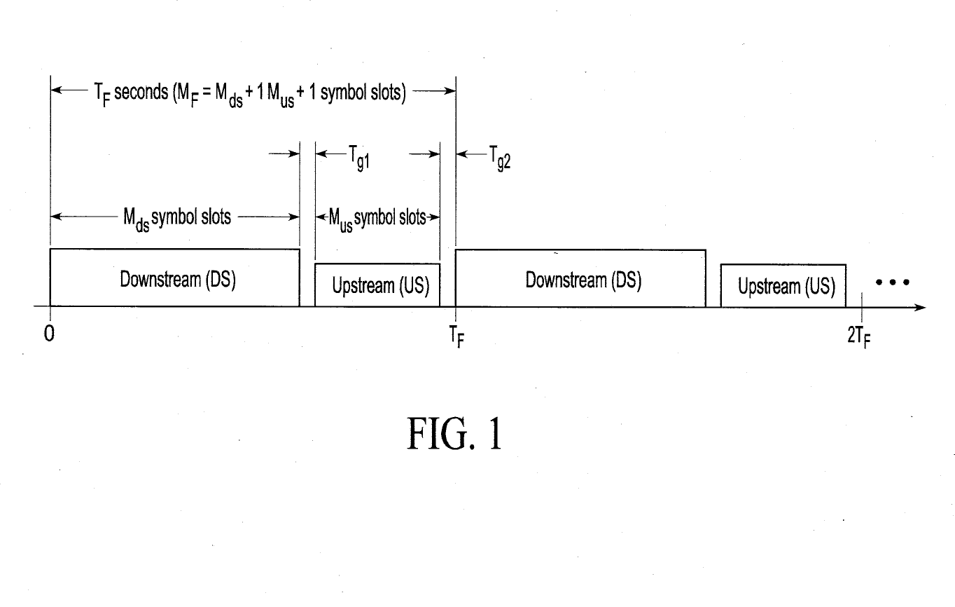

FIG. 1 shows a timing diagram of TDD operation defined for G.fast. One TDD frame has M_{F}=M_{ds}+Mᵤₛ+1 time slots (i.e. discrete multitone (DMT) symbol periods), where M_{ds} is the number of contiguous time slots allocated for downstream transmission, Mᵤₛ is the number of contiguous time slots for upstream transmission, and a total distributed gap period (Tg1+Tg2) equal to 1 time slot for reconfiguration of transmission (or reception) direction.

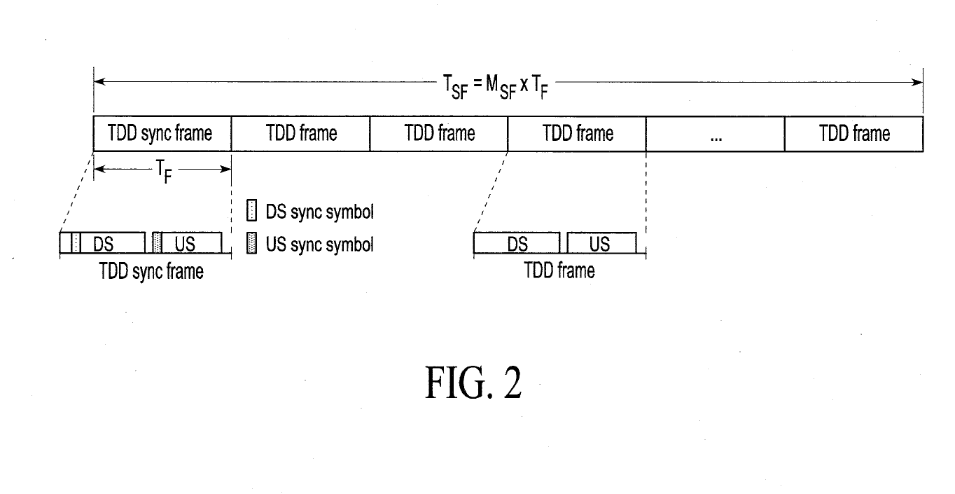

To facilitate operations and management on each G.fast link, a superframe is defined. FIG. 2 shows the timing diagram of a superframe (SF). The superframe contains M_{SF} TDD frames. A special DMT symbol called the sync symbol serves as the delimiter for the superframe. The TDD frame containing the sync symbol is called the TDD sync frame. A sync symbol is defined for each of the downstream and upstream transmission directions and they both reside in the TDD sync frame. In addition to serving as a delimiter, the sync symbol is also used to modulate a bit of the pilot sequence for learning the crosstalk couplings of the channel matrix. Also, the sync symbol is used as a demarcation point for implementing parameter changes via on-line reconfiguration (OLR) activity.

In an effort to save on transceiver power dissipation, G.fast defines the use of discontinuous operation (DO) that facilitates implementations that scale transceiver power dissipation proportional to the average data traffic demand. The fundamental principle is to transmit the minimum amount of data symbols per TDD frame to meet the traffic demand while transmitting quiet (no transmit signal energy) throughout the remaining available symbol periods in the frame; the periods of quiet transmission should translate into power savings, because selected circuits may be turned off during the quiet periods.

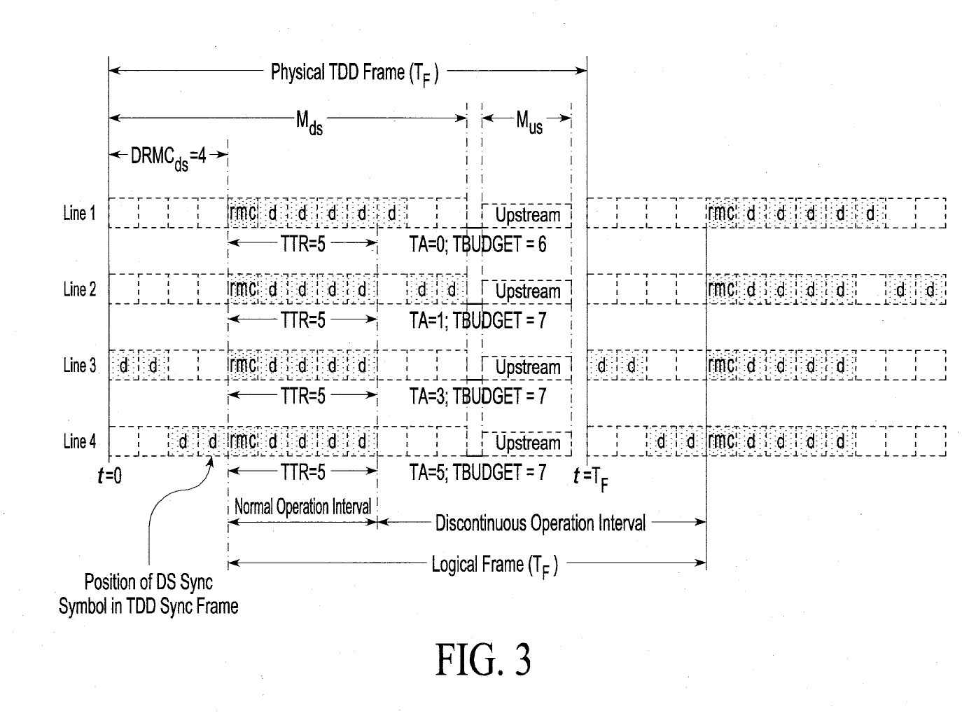

The discontinuous operation capability is illustrated by the timing diagram in FIG. 3 for the downstream direction. This example shows four lines forming a vectored group; each of the TDD frames are aligned in time as configured by a centralized timing control circuit in the DPU. In each TDD frame there is a symbol period designated for transmission of a Robust Management Channel (RMC) in addition to end user data. The RMC communicates management information to the far-end receiver. The RMC symbol may be placed anywhere in the physical TDD frame, but the time slot location for the RMC must be the same for all of the lines in the vectored group. The parameter DRMC_{ds} defines the shift in number of symbol periods (i.e. time slots) from the physical edge of the TDD frame; in the example of FIG. 3 the shift value is four time slots. This shift is centrally configured for the vectored group of lines.

The number of sequential time slots from the RMC symbol in one frame to the RMC symbol in the next frame defines a logical frame; the example in FIG. 3 shows a downstream logical frame containing 12 time slots (the same number of time slots as in the physical frame, i.e. M_{ds}=12 slots). The logical frame is divided into two intervals: the Normal Operation Interval (NOI) and the Discontinuous Operation Interval (DOI), In the NOI, all lines transmit data for the full duration (if there is no data available for the slot, either dummy data or idle symbols are sent), and the vector group operates with full vectoring (in this example a 4×4 channel matrix is used). In the DOI, the data for each line is strategically placed so as to minimize the processing necessary to support the given data throughput. In the example of FIG. 3, the DOI is configured such that only one line in the vectored group is transmitting data at one time; with this configuration, there is no crosstalk to deal with so the vector processor may be disabled during this period and corresponding power dissipation savings may be achieved.

The configuration of the logical frame is communicated to the far-end receiver via the RMC using the parameters TBUDGET, TTR, and TA, where TBUDGET defines the number of active time slots within the logical frame, TTR defines the length of the NOI in number of time slots, and TA defines the number of quiet symbol periods (i.e. time slots) at the beginning of the DOI. In the example, line 3 has TBUDGET=7, TTR=5, and TA=3; this leaves TBUDGET=TTR=7=2=2 time slots of data transmission in the DOI beginning in the time slot following a period of TA=3 time slots of quiet. It should be apparent that the numbers of lines and time slots per frame in these examples are provided for illustration purposes only, and the numbers of lines and/or time slots are typically substantially greater in actual implementations.

As set forth above, the G.fast transceiver specification has been defined on the assumption of a single vector group that exists to accommodate all of the lines in the DPU, It should be noted that if more than one vector group were to exist in the cable where data transmission of each group occurs at the same time, the crosstalk between separate vector groups remains uncancelled and the performance on all of the lines may become severely degraded if the residual uncancelled crosstalk is large enough.

Likewise, if a specific implementation of a vectored group has a size is less than the number of lines in the cable, i.e. the number of lines in a cable is greater than the number of lines in a single vector group, then full crosstalk cancellation cannot be achieved across the wire pairs in the entire cable. The present inventors recognize that if multiple vectored groups are to be implemented in a single DPU, then management must be applied to the signal to deal with any potential un-cancelled crosstalk among the different vector groups. For a G.fast environment, one possibility is to centrally configure and control the operation of the vectored groups in the DPU such that only one vector group is transmitting at a single time. This is effectively time division multiple access applied to full vectored groups.

In accordance with certain general aspects, embodiments of the invention include methods of centrally managing crosstalk in a single DPU implementing multiple vectored groups whose time division duplexed frames are all synchronized and properly aligned.

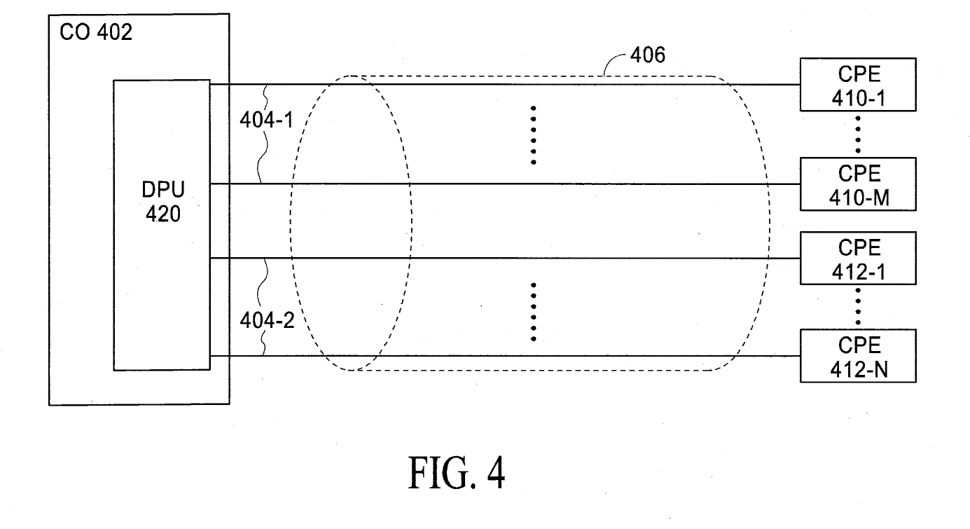

For example, as shown in FIG. 4, consider a cable (i.e. single bundle) 406 that includes wire pairs 404, including wire pairs 404-1 coupled between M G.fast CPE transceivers 410 and corresponding G.fast CO transceivers (i.e. modems) in DPU 420 forming a first vectored group while other pairs 404-2 are coupled between N G.fast CPE transceivers 412 and G.fast CO transceivers in DPU 420 forming a second vectored group. In one example version of G.fast, all of the G.fast transceivers are capable of operating using a bandwidth of up to 106 MHz or more (M and N are integers equal to or greater than one, and may or may not be the same).

It should be noted that G.fast transceivers 410, 412 and G.fast transceivers in DPU 420 include DSL transceivers having processors, chipsets, firmware, software, etc. that implement wideband TDD communication services up to 106 MHz, for example, as defined in the G.fast standard. Accordingly, such processors, chipsets, firmware, etc, are adapted with the functionalities of the present invention in addition to, or alternatively to, the functionalities defined by the G.fast standard. Those skilled in the art will be able to understand how to adapt such processors, chipsets, firmware, software, etc. to implement such functionalities after being taught by the above and following examples.

According to certain aspects of the invention, when multiple vectored groups of time division duplexed transceivers are to be implemented in a single box such as DPU 420, the present inventors recognize that it is advantageous to have centralized control of transmission to avoid and/or manage any un-cancelled crosstalk. In embodiments in which the transceivers operate with time division duplexing and the timing and frames of all transceivers are respectively synchronized and aligned, then the vectored groups may be centrally controlled in the DPU so as to allow only one vectored group to transmit data at any given time. A central protocol within the DPU may administer the times at which each vectored group would transmit data in the cable. In certain embodiments, when one vectored group is active, the lines within that vectored group operate with maximum throughput performance for the times allotted for transmission avoiding any un-cancelled crosstalk from other vector groups in the DPU. The trade-off is that overall average throughput of each line would be equal to the maximum throughput of continuous transmission (i.e. maximum available throughput) scaled by the number of vectored groups in the DPU and corresponding portion of their average transmission within a frame. It is assumed that the cable crosstalk conditions are such that if all vectored groups were transmitting at the same time, then the crosstalk among the vectored groups would cause degradation high enough to cause worse average throughput than the case of controlled transmission to avoid crosstalk.

In embodiments of the invention, it is assumed that each line 404 operates with time division duplexing as described above in connection with FIG. 1 per the G.fast standard. In this baseline configuration, the timing diagram shows the maximum time allotted for the configured downstream (M_{ds} timeslots) and upstream channels (Mᵤₛ timeslots); so having all the M_{ds}+Mᵤₛ timeslots filled represents the case of maximum available throughput. The upstream and downstream rates are proportional to the amount of time allocated to its transmission direction relative to the frame period (T_{F}). If only one vectoring group is active, all of the lines in the same group must be configured with the same TDD frame parameters.

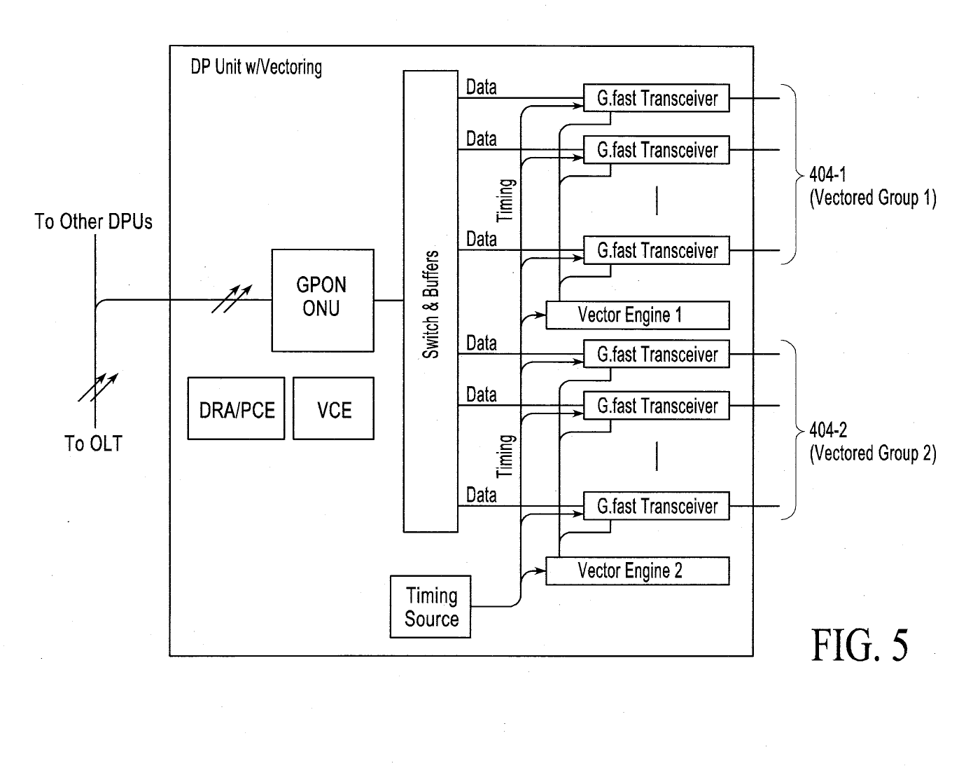

FIG. 5 shows an example DPU 420 that implements different vectored groups according to embodiments of the invention. In the example of FIG. 5, Vector Engine 1 cancels the crosstalk among the lines 404-1 coupled to CPEs 410 and Vector Engine 2 does similar for the lines 404-2 coupled to CPEs 412. Those skilled in the art will be able to understand how to implement more than two vectored groups per the illustrations in the present examples.

FIG. 5 further illustrates an example architecture of DPU 420 that uses GPON as the technology for the network backhaul and G.fast transceivers for serving end users at their respective premises (e.g. homes). As shown in FIG. 5, to align the TDD frames of each G.fast transceiver, a single timing source common to all transceivers is required. The Vectoring Engines are the processing blocks that perform actual crosstalk cancellation, for each direction of transmission, on the data being transmitted and received in each group. The respective groups of G.fast transceivers for which vector processing by each Vector Engine are performed are referred to as the vectored groups (i.e. vectored group 1 and vectored group 2).

To manage the vectoring operation, there is a centralized block referred to as the Vector Control Entity (VCE) that manages the vectoring operations across all of the transceivers in the vectored groups. Management operations include learning the crosstalk channel, tracking changes in the channel characteristics, adding new users (lines) to a vectored group, and removing users from vectored groups. Management operations also include configuring communications by each vectored group to prevent inter-group crosstalk according to aspects of the invention to be described in more detail below.

Another centralized function in the example DPU 420 shown in FIG. 5 is the dynamic resource allocation (DRA) function which manages processing resources in the DPU as a function of the traffic demand, and the power control entity (PCE) manages the system powering functions. The illustrated components of DPU 420 can be implemented by chipsets, firmware and software included in Nodescale Vectoring products of Ikanos Communications, Inc. Those skilled in the art will understand how to adapt such chipsets, firmware and software for use in the present invention after being taught by the descriptions below.

It should be noted that in the illustrated example of FIG. 5, a dedicated vectoring engine is provided for performing processing for crosstalk cancellation within a single vector group (i.e. there is one vector processor per vector group). However, in other possible examples, a central processor or processing engine could implement multiple vector processors.

As set forth above, an issue with this configuration is that the crosstalk between the wire-pairs 404-1 and 404-2 of the two different vector groups is not cancelled, which could cause degradation in throughput of each line. The severity of the degradation depends on the crosstalk couplings between the lines of the two vector groups. If the crosstalk couplings are small, then it may be acceptable to operate the two vector groups at all times, and accept the degraded throughput. However, if the crosstalk couplings are large, it may be advantageous to limit transmission times of each vector group such that crosstalk between the two groups is avoided. For this case the maximum achievable throughput would be scaled by the duty cycle of the transmission periods but it may provide a larger throughput than if operating in the presence of un-cancelled crosstalk among the two groups. The decision for selecting the mode of operation may be based on a-priori knowledge of the cable characteristics should the data be available.

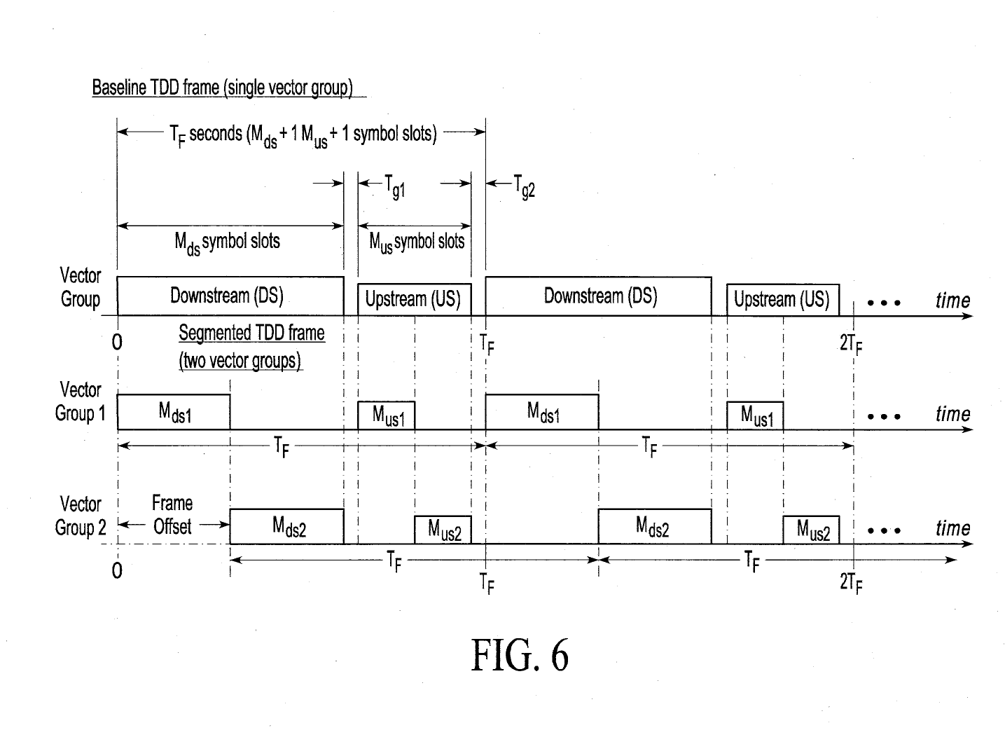

FIG. 6 illustrates an example TDD frame structure configured by the DRA module of DPU 420 in support of two vector groups according to embodiments of the invention. For comparison purposes, the general baseline configuration of a TDD frame (using parameter terminology from the G.fast standard) for a single vectoring group such as that shown in FIG. 1 is also provided.

As shown in the example of FIG. 6, the DRA module configures the G.fast transceivers to operate such that approximately one half of the time slots in each TDD frame are available for each group, with the timeslots of one vector group being configured to not align or coincide with those of the other vector group. In embodiments, this configuration is totally transparent to the CPEs 412 at the other end of each line, as will be described in more detail below.

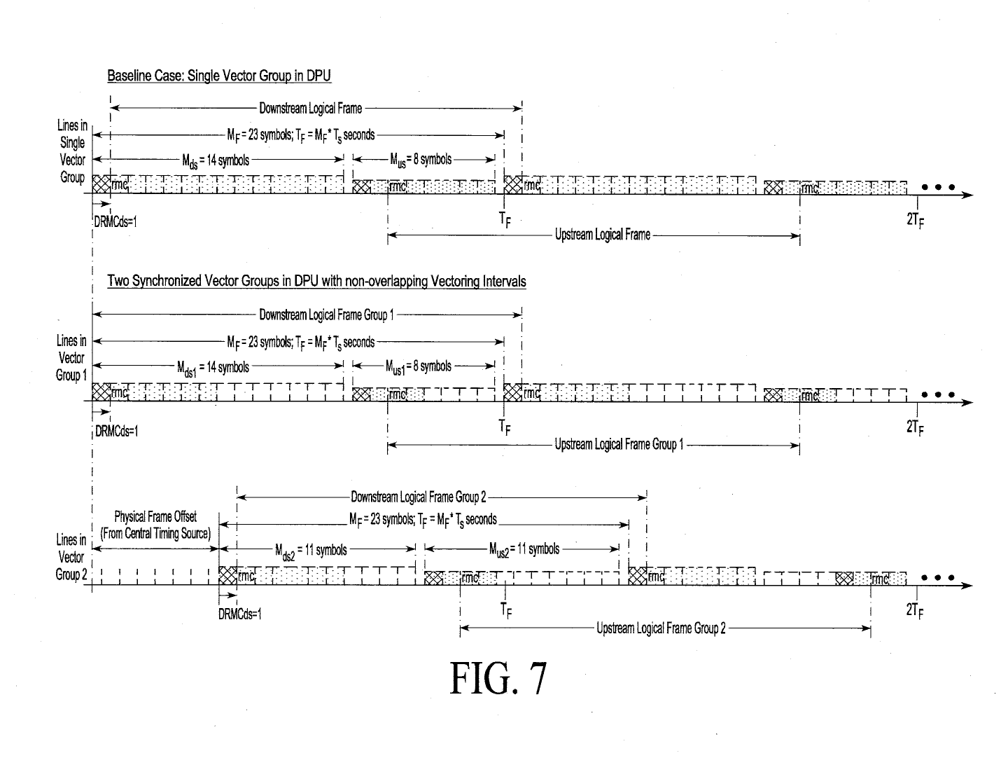

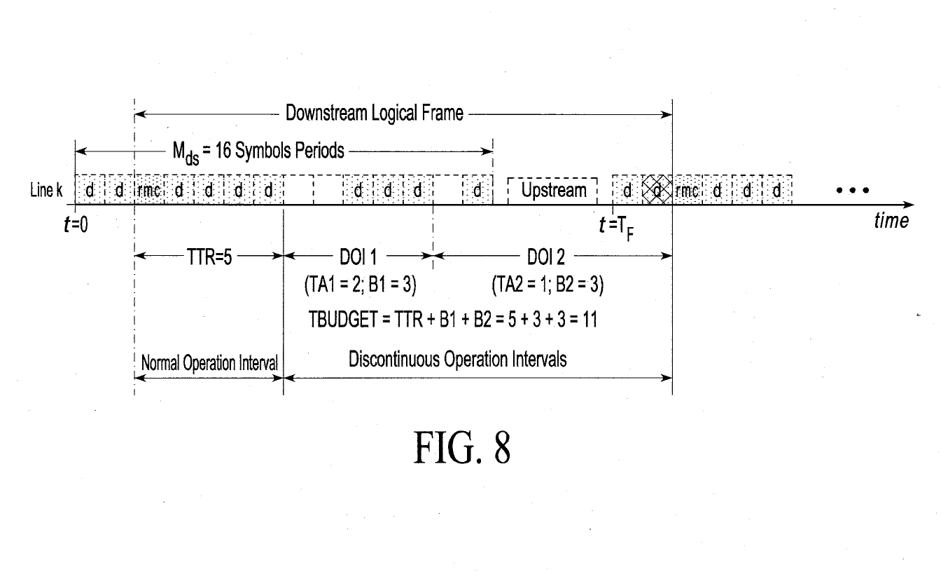

According to certain aspects, in embodiments of the invention, the frame configuration shown in FIG. 6 for two different vector groups can be implemented using the frame offset shown in FIG. 6 and the specifications available with the discontinuous operation protocol in the G.fast standard. This example mechanism will be described in more detail in connection with FIGS. 7 and 8.

In connection with the frame offset specification according to aspects of the invention, a more detailed example of the TDD frame structure is provided in FIG. 7.

As described above in connection with FIG. 3, the RMC positioning as configured by the DRA module allows for the specification of a logical frame for all lines in a vectored group. For example, in the baseline case shown in the top timing diagram of FIG. 7, the specified location of the RMC symbol in both the downstream and upstream portions of the physical frame respectively define the downstream and upstream logical frames. In this example for illustration purposes only, the downstream portion of the physical frame comprises M_{ds}=14 symbols while the upstream portion comprises Mᵤₛ=8 symbols. With the example specification provided in FIG. 7, relative to the boundaries of the physical frame, the logical frame for the downstream transceivers begins at DRMC_{ds}=1 symbol after the start of the downstream portion of the physical frame and the logical frame for the upstream transceivers begins at two symbols after the start of the upstream portion of the physical frame.

To implement the separate vectored groups of the present invention, the DRA module specifies separate physical frame boundaries for the transceivers in the two separate vectored groups. More particularly, as shown in the two lower timing diagrams in FIG. 7, the physical frames of both vectored groups include the same total number of downstream and upstream symbols (i.e. 23) as in the baseline configuration shown in the top timing diagram.

However, the DRA module of DPU 420 configures the central timing source such that the boundary of the physical frames of the first vectored group is offset from the boundary of the physical frames of the second vectored group. Note also that, while the total number of symbols in the physical frames are the same, the numbers of downstream and upstream symbols in the physical frames for the transceivers in the first vectored group (i.e. M_{da}=14 symbols and Mᵤₛ=8 symbols) are configured to be different from the physical frames for the transceivers in the second vectored group (i.e. M_{ds}=11 symbols and Mᵤₛ=11 symbols).

In addition to configuring the physical frame offset, to ensure that the downstream and upstream transmissions of the first and second vectored groups do not overlap, embodiments of the invention utilize the configurations of the NOI and DOI for each vectored group available with the discontinuous operation feature of the G.fast standard as described above in connection with FIG. 3.

More particularly, to permit greater flexibility in placement of timeslots in the logical frame so as to avoid transmissions from lines in different vectored groups occupying the same time slot positions, the number of discontinuous operation sub-intervals can be extended as shown in FIG. 8. In this example, to allow for the implementation of two vectored groups, the DRA module of DPU 420 breaks up the discontinuous operation interval for the downstream logical frame into two sub-intervals: DOI 1 and DOI 2. It should be noted that similar configuration for the upstream logical frame can also be provided. Following the same framework in the G.fast standard, the format of each sub-interval is defined by a variable TAi and Bi, where each sub-interval DOIi, TAi defines the number of quiet symbol periods followed by Bi data symbol periods; the index i identifies the specific DOI sub-interval, In each TDD frame, there is still only one NOI, whose duration is identified by the parameter TTR. The parameter TBUDGET defines the number of data symbol periods in a logical frame; its value is the sum of TTR plus the sum of the Bi values of each DOI in the logical frame.

Accordingly, to implement the baseline frame configuration in FIG. 6 (i.e. when only one vectored group is operational), the DRA module of DPU 420 configures the transceivers in the one vectored group to use sub-interval DOI 1. To implement the segmented frame configuration of FIG. 6 (i.e. when two different vectored groups are simultaneously needed), the DRA module of DPU 420 may configure the transceivers in both vectored groups to use more than one DOI sub-interval.

Per the protocol defined in the G.fast standard, the values of TBUDGET, TTR, and all TAi Bi values are communicated to the far-end receivers via the RMC channel. In embodiments, this protocol can be implemented as described in co-pending U.S. application Ser. No. 14/515,894, the contents of which are incorporated herein by reference in their entirety. During initialization, all joining lines may initialize in time slots aligned with the normal operation interval as currently defined in the G.fast standard, independent of the number of discontinuous operation intervals.

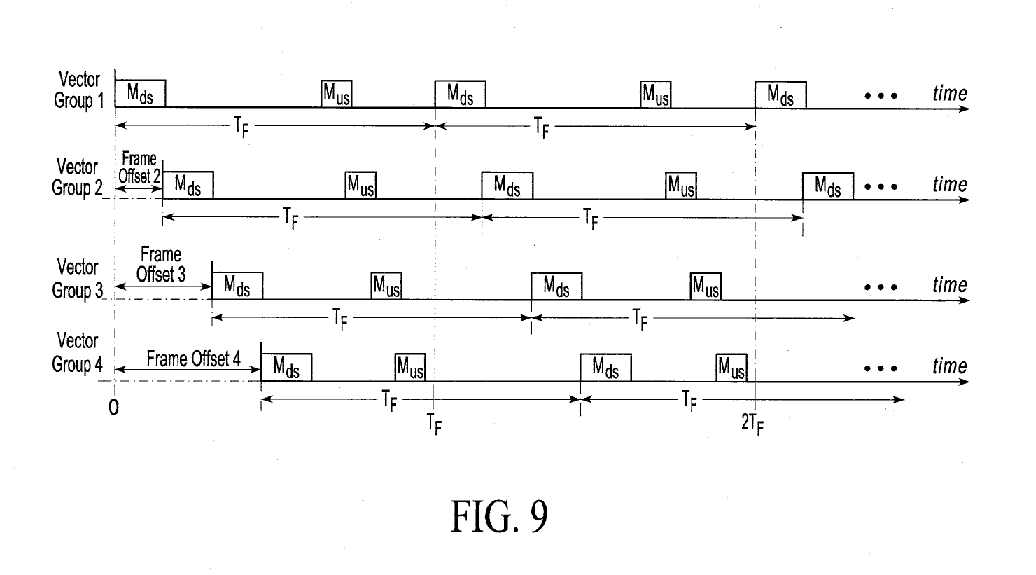

As set forth above, the principles of the invention can be extended to numbers of vectored groups other than two. An example using four vector groups according to embodiments of the invention is provided in FIG. 9. As described above, the frame offsets for groups 2, 3 and 4 are centrally configured by the DRA module of DPU 420 using the central timing source in the DPU 420, transparently to the CPEs of each line.

Although the present invention has been particularly described with reference to the preferred embodiments thereof, it should be readily apparent to those of ordinary skill in the art that changes and modifications in the form and details may be made without departing from the spirit and scope of the invention, It is intended that the appended claims encompass such changes and modifications.

1. A method of controlling communications by transceivers in a common distribution point unit (DPU), the method comprising:
configuring all of the transceivers to use a time division duplex (TDD) physical frame having a downstream set of discrete multitone (DMT) symbol periods and an upstream set of DMT symbol periods;
configuring first ones of the transceivers to transmit in a first portion of the downstream set of DMT symbol periods of the physical frame; and
configuring second ones of the transceivers to transmit in a second portion of the downstream set of DMT symbol periods of the physical frame,
wherein the first and second portions do not contain any common DMT symbol periods in the physical frame.

2. A method according to claim 1, wherein the first and second ones of the transceivers are in first and second separate vectored groups for performing crosstalk cancellation, respectively.

3. A method according to claim 2, wherein the all of the transceivers are coupled to loops contained in a common bundle, such that the common bundle contains two or more separate vectored groups for performing crosstalk cancellation.

4. A method according to claim 1, wherein configuring the first and second transceivers to transmit includes defining first and second different downstream logical frames, respectively, wherein the first and second different downstream logical frames both contain the same number of DMT symbol periods but are aligned in time at different positions within the physical frame.

5. A method according to claim 4, wherein defining the first and second different downstream logical frames includes defining first and second different positions of a robust management channel (RMC) symbol in the downstream set of DMT symbol periods.

6. A method according to claim 4, wherein defining the first and second different downstream logical frames includes defining a normal operation interval in both of the first and second different downstream logical frames and at least two different discontinuous operation sub-intervals in both of the first and second different downstream logical frames.

7. A method according to claim 6, wherein configuring the first and second transceivers to transmit includes configuring the first and second transceivers to transmit during the normal operation interval and in one or more of the two different discontinuous operation sub-intervals.

8. A method according to claim 1, wherein the communications are in accordance with G.fast.

9. A distribution point unit (DPU) comprising:
a plurality of transceivers; and
a dynamic resource allocation (DRA) function, the DRA having circuitry adapted to:
configure all of the transceivers to use a time division duplex (TDD) physical frame having a downstream set of discrete multitone (DMT) symbol periods and an upstream set of DMT symbol periods;
configure first ones of the transceivers to transmit in a first portion of the downstream set of DMT symbol periods of the physical frame; and
configure second ones of the transceivers to transmit in a second portion of the downstream set of DMT symbol periods of the physical frame,
wherein the first and second portions do not contain any common DMT symbol periods in the physical frame.

10. A DPU according to claim 9, further comprising:
a first vector engine for performing crosstalk cancellation for the first transceivers; and
a second vector engine for performing crosstalk cancellation for the second transceivers, such that the common bundle contains two or more separate vectored groups for performing crosstalk cancellation.

11. A DPU according to claim 10, wherein the all of the transceivers are coupled to loops contained in a common bundle.

12. A DPU according to claim 9, wherein configuring the first and second transceivers to transmit includes defining first and second different downstream logical frames, respectively, wherein the first and second different downstream logical frames both contain the same number of DMT symbol periods but are aligned in time at different positions within the physical frame.

13. A DPU according to claim 12, wherein defining the first and second different downstream logical frames includes defining first and second different positions of a robust management channel (RMC) symbol in the downstream set of DMT symbol periods.

14. A DPU according to claim 12, wherein defining the first and second different downstream logical frames includes defining a normal operation interval in both of the first and second different downstream logical frames and at least two different discontinuous operation sub-intervals in both of the first and second different downstream logical frames.

15. A DPU according to claim 14, wherein configuring the first and second transceivers to transmit includes configuring the first and second transceivers to transmit during the normal operation interval and in one or more of the two different discontinuous operation sub-intervals.

16. A DPU according to claim 9, wherein the transceivers are G.fast transceivers.
